(19) United States
(12) Patent Application Publication
(10) Pub. No.: US 2005/0157451 A1
(43) Pub. Date: Jul. 21, 2005

(54) Intelligent power socket

(76) Inventor: Chin-Chang Kuo, Taipei Hsien (TW)

Correspondence Address: TROXELL LAW OFFICE PLLC, SUITE 1404, 5205 LEESBURG PIKE, FALLS CHURCH, VA, 22041, US

(21) Appl. No.: 10/758,082

(22) Filed: Jan. 16, 2004

(51) Int. Cl. H02B 1/26

(52) U.S. Cl. 361/622; 361/628

(57) ABSTRACT

The present invention discloses an intelligent power socket, which comprises a first socket being connected to a second socket by a compare amplify circuit, and the second socket having a control circuit. The compare amplify circuit compares the voltage outputted from the first socket with a standard voltage and outputs a signal to the control circuit, so that the control circuit will follow the instruction given by the signal to turn on or off the power of the second socket as the power of the first socket is turned on or off. The present invention not only reduces the power consumption, but also turns off the power of all sockets automatically, and thus making the operation simple and easy.

### FIELD OF THE INVENTION

The present invention relates to an intelligent power socket, more particularly to a power socket that can turn off the power of the peripherals of an electric appliance when the power of such electric appliance is turned off.

### BACKGROUND OF THE INVENTION

In general, the power socket of a traditional extension cord comprises a base with a plurality of sockets, and such base is connected to a power supply by an external extension circuit, so that the circuit is connected to the power supply, and power can be supplied to each electric appliance connected to each socket. However, such device has only one master switch, and cannot turn off particular sockets, and thus causing unnecessary consumption of electric power.

To overcome the shortcomings of the foregoing traditional socket, a socket with control switches to individually control every socket is designed. Although such arrangement can reduce power consumption, it still requires the user to turn on or off each control switch for its application. Therefore, it is necessary to manually turn off the control switches of related electrical appliances connected to the power socket one by one. Now, we take the combination of television, tape-recorder, and speaker; the combination of stereo system and the stereo speaker; and the combination of computer system, monitor, and other peripherals for examples. When the power of the main electric appliance is turned off, its related electric appliances connected to the power sockets must be turned off one by one manually by the control switch. Therefore, such arrangement is troublesome, and users may forget to turn on or off some of the control switches.

In view of the shortcomings of the traditional device described above, the inventor of this invention focused on its problems and started thinking for an improvement to overcome such shortcomings and find a feasible solution. After extensive research and development, the inventor finally invented and designed the intelligent power socket in accordance with this invention.

### SUMMARY OF THE INVENTION

The primary objective of the present invention is to provide an intelligent power socket, which comprises a first socket, a second socket; a compare amplify circuit, and a control circuit disposed between the first socket and the second socket, wherein the compare amplify circuit is mainly used to compare the voltage outputted from the first socket with a standard voltage, and the control circuit is used to compare the signal sent from the compare amplify circuit after the comparison and control the ON and OFF states of the power of the second socket. For example, when the power of an electric appliance is disconnected from the first socket, the compare amplify circuit will output a high potential signal to the control circuit, so that power will not be supplied to the second socket, and thus turning off the electric appliance connected to the second socket. This invention not only saves power, but also turns off the power of the electric appliances connected to the second socket automatically as the power of the electric appliance connected to the first socket is turned off, and thus making the operation simple and easy.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

FIG. 1 is a perspective diagram of the disassembled parts of the structure according to a preferred embodiment of this invention.

FIG. 2 is a perspective diagram of the assembled structure according to a preferred embodiment of this invention.

FIG. 3 is a schematic circuit diagram of a preferred embodiment of this invention.

FIG. 4 is a diagram of a preferred embodiment of this invention.

### DETAILED DESCRIPTION OF THE PREFERRED EMBODIMENTS

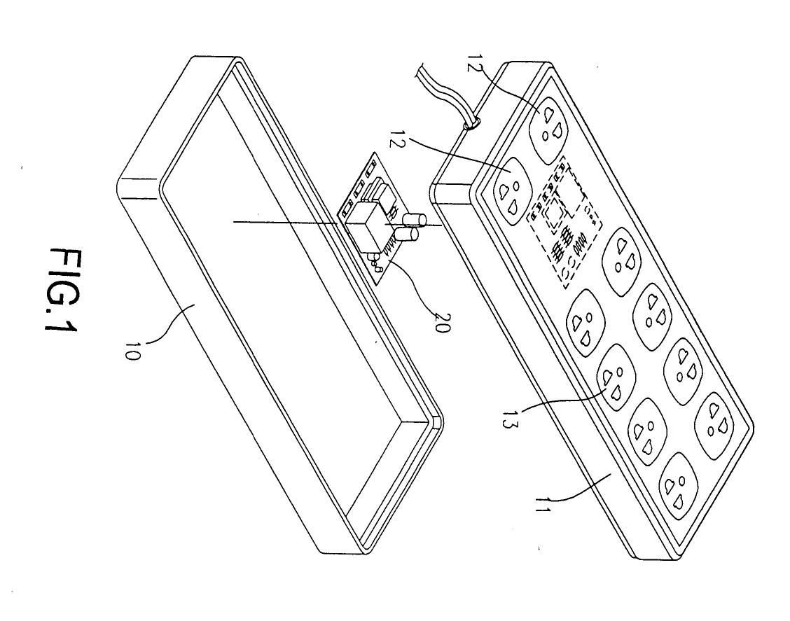

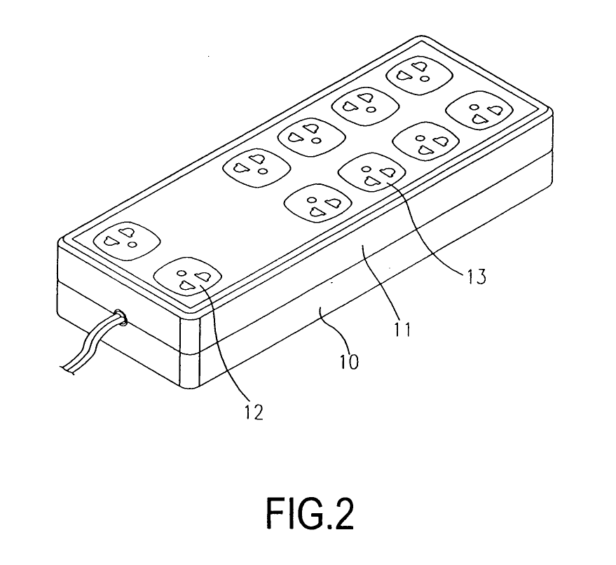

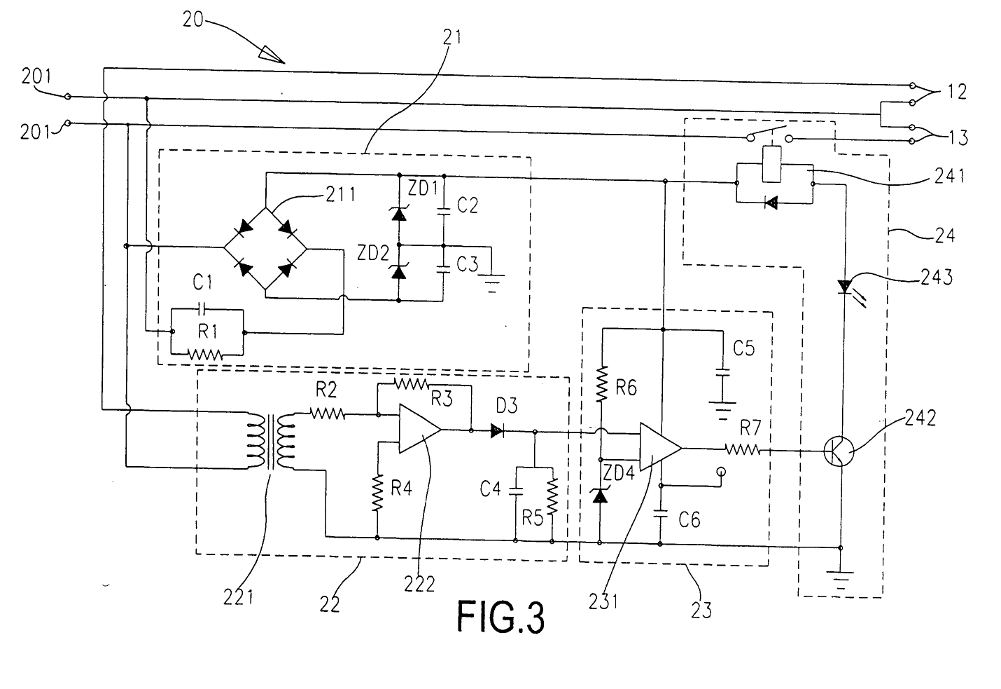

Please refer to FIGS. 1 and 2 for the intelligent power socket of this invention. In the figures, the power socket comprises a base 10, a casing 11 for covering the top of the base 10, at least a first socket 12 and a second socket 13 disposed on the casing 11, a printed circuit board (PCB) 20 disposed in the base 10 as shown in FIG. 3, an input end 201 disposed on the printed circuit board 20 being coupled to an external power supply, and the input end 201 of the external power supply being connected with the first socket 12 and the second socket 13, and the output end of the external power supply being connected to a rectification circuit 21 by an electric circuit. The rectification circuit 21 further comprises a parallel capacitor C1 and a resistor R1 for lowering the voltage of an alternate current, and the capacitor C1 and the resistor R1 are coupled to a bridge rectifier (BD) 211, Zener Diodes ZD1, ZD2, and capacitors C2, C3 by an electric circuit, so that after the voltage of the alternate current is lowered, the alternate current will be converted into a pulse direct current of 12V by the bridge rectifier 211, Zener Diodes ZD1, ZD2 and capacitors C2, C3, and also will modify the pulse alternate current into a constant smooth direct current.

Further, the rectification circuit 21 is connected to a sampling amplify circuit 22, and the sampling amplify circuit 22 is connected to the first socket 12, and the sampling amplify circuit 22 has a transformer 221. The transformer 211 is connected to the first socket 12 and the rectification circuit 21, and the transformer 211 is also connected to a feedback amplify circuit which comprises an amplifier 222 and a plurality of resistors R2, R3, R4, and the output end of the feedback amplify circuit is connected to a diode D3, a capacitor C4, and a resistor R5 in series, so that when the power of the first socket 12 is connected, the amplified power is converted into a direct current.

Further, the sampling amplify circuit 22 is connected to a compare amplify circuit 22, and the compare amplify circuit 23 has a comparator 231, and one input end of the comparator 231 is connected to the rectification circuit 21 through the capacitors C5, C6, resistor R6, and Zener diode ZD4, and another end is connected to the sampling amplify circuit 22, and the output end of the comparator 231 is connected to a resistor R7 in series, such that the comparator 231 will compare the voltage inputted from the sampling amplify circuit 22 with the standard voltage outputted from the rectification circuit 21.

In addition, the compare amplify circuit 23 is connected to a control circuit 24 by an electric circuit, and the rectification circuit 21 is connected to the second socket 13. The control circuit 24 has a relay 241, and the relay 241 is connected to a light emitting diode 242 and a transistor 242 in series, wherein the transistor 242 is connected to the output of the compare amplify circuit 23, so that after the compare amplify circuit 23 inputs the compared potential signal, the control circuit will connect or disconnect the relay 241 according to the inputted potential signal, and further turn on or off the power of the second socket 13. The light emitting diode 243 will be lit to indicate the power ON status.

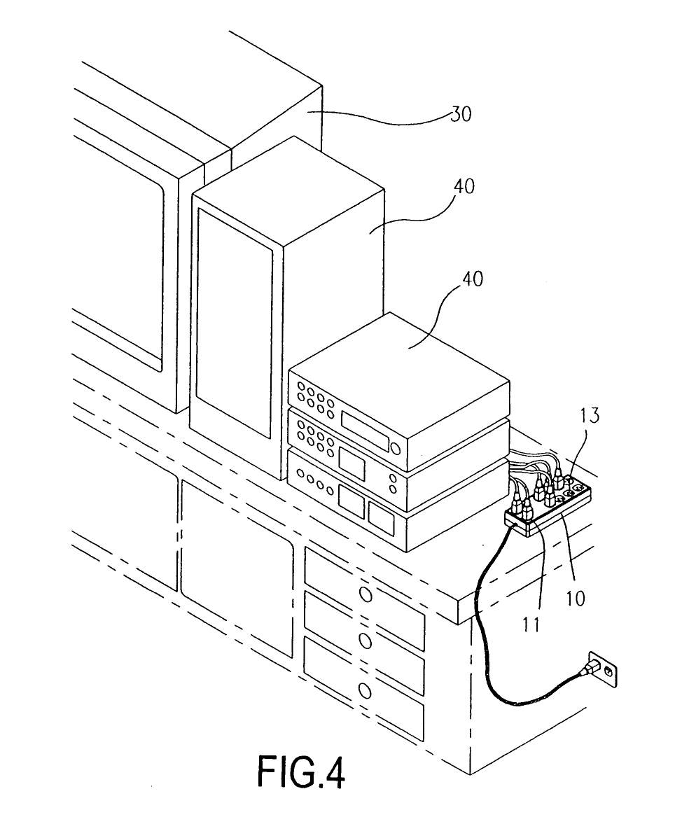

Please refer to FIG. 4 for the intelligent power socket of this invention while it is in use. This invention is applied to an electric appliance having audio and video effects, wherein the power socket of this invention is connected to an external power supply by an electric circuit, so that the power can be supplied to the first socket 12 and the second socket 13, and then the power connector of the television 30 is plugged into the first socket 12 and related equipments 40 such as a videotape recorder and a stereo player are connected to the second socket 13. Therefore, if the power from the external power supply is inputted into the first socket 12 and the television is turned on, then the sampling amplify circuit 22 will convert the voltage of the alternate current inputted to the first socket 12 into the voltage of the direct current, and then send the voltage to the compare amplify circuit 23. The compare amplify circuit will compare the inputted voltage with a standard voltage, and then input a low potential signal to the control circuit 24, such that the relay is connected, and every equipment connected to the second socket 13 will be turned on accordingly. In the meantime, the light emitting diode 243 will be lit to indicate the power ON status. On the contrary, if the power of the television connected to the first socket 12 is turned off, the compare amplify circuit 23 will output a high potential signal to the control circuit 24, so that the relay 241 is disconnected, and the power of every equipment connected to the second socket 13 will be turned off accordingly. Such arrangement not only saves power, but also turns off the power of all electric equipments connected to the second socket 13 automatically when the power of the electric equipment connected to the first socket is turned off, and thus making the operation simple and easy.

In summation of the above description, the intelligent power socket of the present invention herein enhances the shape, structure, device, and performance over the conventional structure and overcomes the shortcomings of the prior art. This invention also complies with the patent application requirements and thus is submitted to the Patent and Trademark Office for review and granting of the commensurate patent rights.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

1. An intelligent power socket, comprising:
a base, having a casing for covering the top of said base, and said casing at least having a first socket and a second socket, and said first and second sockets being respectively connected to a power supply;
a printed circuit board, being installed at the inner bottom of said base, and further comprising a rectification circuit, and said rectification circuit adjusting an alternate current to a direct current with constant voltage;
a sampling amplify circuit, being coupled to said first socket and said rectification circuit, and converting the alternate current entering said first socket into a direct current;
a compare amplify circuit, being coupled to said sampling amplify circuit and second socket, and comparing the voltage of the current outputted from said sampling amplify circuit with the voltage outputted from said rectification circuit, and outputting a potential signal according to the comparison result;
a control circuit, being coupled to said compare amplify circuit and second socket, and controlling the ON and OFF states of the power of said second socket with respective to the signal inputted from said compare amplify circuit;
by means of foregoing elements, said compare amplify circuit comparing the voltage outputted from said first socket with a standard voltage, and sending a signal to said control circuit, thereby said control circuit turning the power of said second socket on and off with respective to the on and off states of said first socket according to said potential signal, and thus not just saving power, but also disconnecting the power of all sockets without switching off the power of each socket manually.

2. The intelligent power socket of claim 1, wherein said rectification circuit comprises a capacitor and a resistor connected in parallel for lowering the voltage of an alternate current, and said capacitor and resistor being coupled to a bridge rectifier, a Zener diode, and a capacitor by an electric circuit, thereby the alternate current after its voltage being reduced by said capacitor and resistor is converted into a pulse direct current of constant voltage by said bridge rectifier, Zener diode, and capacitor, and said pulse direct current is modified into a constant smooth direct current.

3. The intelligent power socket of claim 1, wherein said sampling amplify circuit comprises a transformer coupled to said first socket and rectification circuit, and also to a feedback amplify circuit, and the output end of said feedback amplify circuit is connected to a diode, a capacitor, and a resistor in series, such that when the power of said first socket is connected, the sampling amplify circuit amplifies the power and converts the alternate current into a direct current.

4. The intelligent power socket of claim 1, wherein said compare amplify circuit comprises a comparator, and the input end of said comparator is connected to said rectification circuit through said capacitor, resistor, and Zener diode, and another end of said comparator is connected to said sampling amplify circuit, and the output end is connected to a resistor in series, so that said comparator compares the voltage inputted from said sampling amplify circuit with the standard voltage outputted from said rectification circuit.

5. The intelligent power socket of claim 1, wherein said control circuit comprises a relay, and said relay is connected with said second socket in series.

6. The intelligent power socket of claim 1, wherein said control circuit comprises a light emitting diode for indicating the status of the power supply.
